(19) United States
(12) Patent Application Publication
(10) Pub. No.: US 2006/0060099 A1
(43) Pub. Date: Mar. 23, 2006

(54) Method of printing onto a box or packaging medium for golf balls

(75) Inventor: Takashi Ohira, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE SPORTS CO., LTD.

(21) Appl. No.: 11/225,021

(22) Filed: Sep. 14, 2005

(30) Foreign Application Priority Data
Sep. 17, 2004 (JP) 2004-271399

(51) Int. Cl. B41F 33/00

(52) U.S. Cl. 101/483; 206/459.5

(57) ABSTRACT

A method is disclosed which enables a label that includes lettering or a design desired by the consumer to be easily and rapidly printed onto the surface of a golf ball box or packaging medium with an inkjet printer.

### CROSS-REFERENCE TO RELATED APPLICATION

This non-provisional application claims priority under 35 U.S.C. §119(a) on Patent Application No. 2004-271399 filed in Japan on Sep. 17, 2004, the entire contents of which are hereby incorporated by reference.

### BACKGROUND OF THE INVENTION

1. Field of the Invention

The present invention relates to a method which is useful for printing a label that includes lettering or a design onto the surface of a golf ball box or golf ball packaging medium. The invention relates also to a printed golf ball box and a printed golf ball packaging medium.

2. Related Art

Golf balls on which personalized marks such as names and designs have been printed are widely used not only to help a golfer identify his or her own balls, but also for advertising purposes and as keepsakes and commemorative items. However, the boxes used to hold the golf balls have not been personalized in the same way. Processes for printing a desired label onto golf ball boxes include a method that involves color separating a single image into black, cyan, magenta and yellow, forming a plate for each of these colors, printing the plates onto the surface of a base material such as paper by any of various suitable processes such as gravure printing or screen printing, carrying out embossing or hot stamping if necessary, then applying a protective film and punching the completed packaging material into the required shape for assembly into a box. Unfortunately, because the work involved in using such a process to print the personalized labels desired by a small number of customers is time-consuming, this is not an approach that lends itself to rapid and trouble-free printing.

In addition, JP-A 2000-219234 discloses a golf ball box in which, to impart a stylish appearance, part or all of the box surface has a vapor-deposited metal thin-film thereon, the thin-film being optionally laminated onto a paper base by an adhesive layer. However, the need for a vapor-deposited metal thin-film increases the production costs, resulting in a printing method that is anything but simple and convenient.

### SUMMARY OF THE INVENTION

It is therefore an object of the invention to provide a method of printing onto a golf ball box or packaging medium which can easily, conveniently and rapidly print a label that includes lettering or a design desired by the consumer onto a small number of golf ball boxes or a small quantity of golf ball packaging medium. Another object of the invention is to provide such printed golf ball boxes and such a golf ball packaging medium.

Accordingly, the invention provides a method of printing onto a golf ball box or golf ball packaging medium, in which method a label that includes lettering or a design is printed onto a surface of the box or packaging medium with an inkjet printer. The golf ball box or packaging medium typically has a three-dimensional shape. The inkjet printer used in the printing method preferably is an on-demand printer and may use a water-based pigment ink. It is desirable for the golf ball box or packaging medium to have an image-receiving layer which absorbs an ink solvent and on a surface of which the label is printed. The image-receiving layer is typically composed of at least one water-absorbing film.

The invention also provides a printed golf ball box or printed golf ball packaging medium composed of a golf ball box or golf ball packaging medium having a surface, and a label that includes lettering or a design printed on the surface of the box or packaging medium with an inkjet printer.

In a preferred aspect of the invention, the printed golf ball box or printed golf ball packaging medium is additionally composed of a protective layer formed on a surface of the label so as to cover the label.

The method of the invention enables a label that includes lettering or a design desired by the consumer to be easily and rapidly printed on the surface of golf ball boxes or a golf ball packaging medium with an inkjet printer.

### BRIEF DESCRIPTION OF THE DIAGRAMS

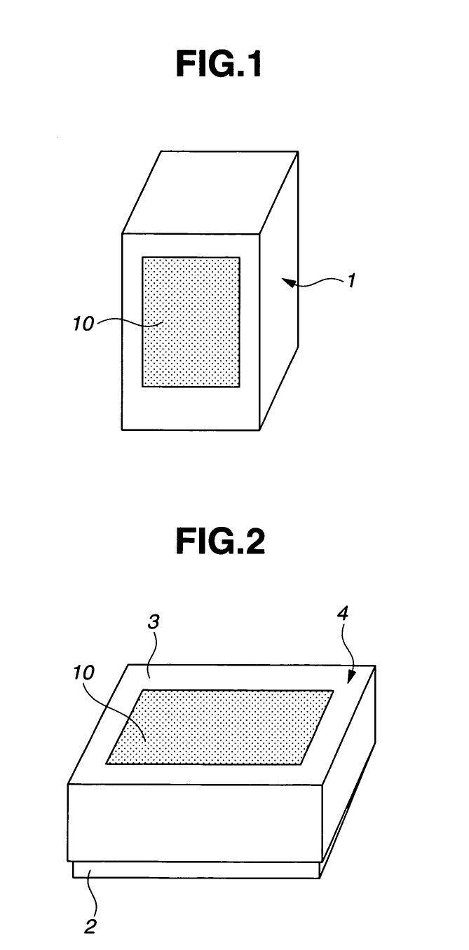

FIG. 1 is a perspective view of a golf ball box according to one embodiment of the invention.

FIG. 2 is a perspective view of a golf ball box according to another embodiment of the invention.

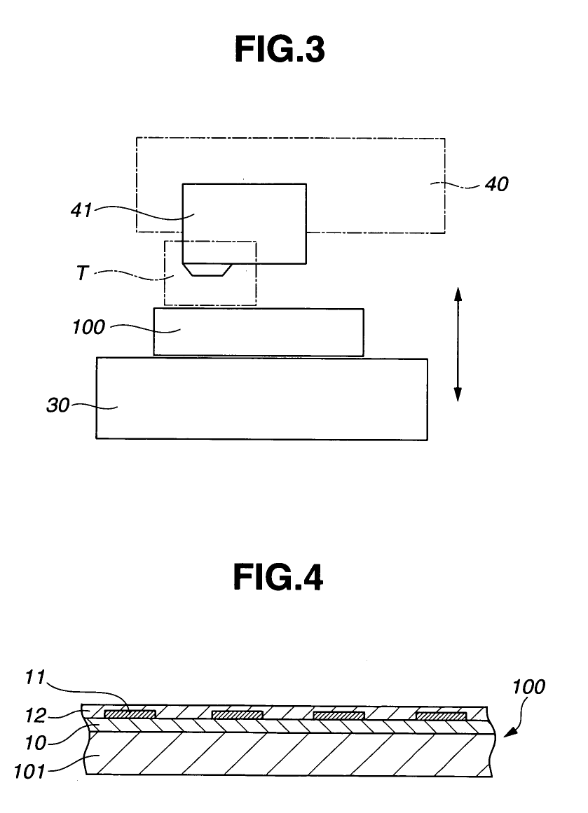

FIG. 3 schematically illustrates the inventive method of printing onto a golf ball box or golf ball packaging medium.

FIG. 4 is a fragmentary cross-sectional view of a laminated structure composed of an image-receiving layer, an ink layer, and a protective layer in a printed golf ball packaging medium according to one embodiment of the invention.

### DESCRIPTION OF THE PREFERRED EMBODIMENTS

The objects, features and advantages of the invention will become more apparent from the following detailed description, taken in conjunction with the foregoing diagrams.

The golf ball box of the invention is typically a small box 1 of rectangular shape for holding from one to three golf balls, as shown in FIG. 1; or a large box 4 composed of a box body 2 which is open at the top and accommodates therein several small boxes of the type shown in FIG. 1, and a lid 3 which fits over and covers the opening at the top of the body 2, as shown in FIG. 2. As used herein, “golf ball packaging medium” refers to the packaging material which makes up golf ball containers of various shapes, including the foregoing golf ball boxes and tubular containers. The term “label” is used herein to refer collectively to ink marks such as lettering and designs that are printed on a surface of the golf ball box or golf ball package.

Basic materials that may be employed in such golf ball boxes or golf ball packaging media include paper, surface-coated paper, and plastics such as polypropylene, polyethylene, polyethylene terephthalate and polylactide resins. Paper is generally used.

In the golf ball box or packaging medium of the invention, the label 10 that includes lettering or a design is formed by printing on a surface of the small box 1, a surface of the lid 3 of the large box 4, or a surface of the packaging medium. The label 10 is printed with an inkjet printer. Generally, in addition to lettering and designs intended for a large number of consumers, special lettering and designs desired by a small number of consumers are also displayed on the surface of the golf ball box or packaging medium.

The inkjet printer used in the invention is not subject to any particular limitation. In terms of ink droplet discharge, use can be made of either a drop-on-demand inkjet printer such as a bubble jet, thermal jet or piezo printer, or a continuous inkjet printer such as a Hertz, Mead or Sweet-type printer. Specific examples of printers that are preferable for use include those having the capabilities described in JP-A 2000-190467. Referring to FIG. 3, printing onto a surface of a golf ball box or golf ball packaging medium 100 is typically performed by placing the golf ball box or golf ball packaging medium 100 on a feed tray 30 and thereby carrying it through a printing position T in a printing unit 40 equipped with an inkjet head 41. The tray 30 can be raised and lowered in the direction of the arrows in the diagram by a gap-adjusting mechanism (not shown). In this way, the size of the gap between the inkjet head 41 and the golf ball box or golf ball packaging medium 100 can be held constant at all times.

No particular limitation is imposed on the ink used in the inkjet printer. For example, use can be made of a water-based dye, water-based pigment, oil-based pigment, water-based thermosetting acrylic pigment, solvent-based pigment or ultraviolet-curing pigment. Generally, a water-based ink can be used. From the standpoint of durability, a pigment-type ink, particularly a water-based pigment ink, is preferred.

The inkjet printer can be connected to a personal computer, and the desired label reliably created by image processing with the computer. With the image data that has been created, the printing operation can be repeatedly carried out in a short time using the inkjet printer. This arrangement is highly suitable for printing designs of all kinds, be they of many types or a few types.

In the practice of the invention, the golf ball box or packaging medium may have an image-receiving layer which absorbs the ink solvent and on a surface of which the label is printed. Moreover, when a water-based ink is employed, it is preferable to use a water-absorbing film so as to attractively finish the label printed with water-based ink. Illustrative examples of the image-receiving layer include those obtained by applying and drying a liquid mixture prepared by mixing ingredients such as a foam inhibitor, a surface conditioner, a surfactant, a tackifier, and water or an alcohol-type solvent into a water-absorbing resin base material such as an aqueous acrylic resin, vinyl alcohol resin, modified urethane resin, polyalkylene oxide resin or vinyl acetate resin. It is also possible to directly apply to paper or the like a thermoplastic water-absorbing resin prepared by mixing a water-absorbing polymer into a polyolefin resin. It is possible as well to form the thermoplastic water-absorbing resin into a film, and thermally fuse the film to the surface of the golf ball box or golf ball packaging medium so as to form the image-receiving layer. Exemplary thermoplastic water-absorbing resins include those obtained by mixing polyethylene oxide, polypropylene oxide and/or a copolymer of both into a polyolefin-type resin such as polyethylene or polypropylene. A specific example is the product available from Sumitomo Seika Chemicals Co., Ltd. under the trade name Aquacalk.

In the practice of the invention, a protective layer can be formed on the surface of the label so as to protect the label. The protective layer is formed so as to prevent color fading of the label and improve its durability. The layer can be obtained by, for example, applying and drying a liquid mixture composed primarily of any of various suitable resins such as a urethane, epoxy, acrylic, silicone acrylic or polyester resin in admixture with various types of ultraviolet absorbers, antioxidants, light stabilizers, foam inhibitors, surface conditioners, crosslinking agents and solvents.

FIG. 4 shows a laminated structure composed of an image-receiving layer, an ink layer and a protective layer on a printed golf ball box or printed golf ball packaging medium according to a preferred embodiment of the invention. In this embodiment, an image-receiving layer 20 of the type described above has been laminated onto a golf ball box or packaging medium 100 having an outer layer 101, a printed label (ink layer) 21 that includes lettering or a design has been laminated onto the image-receiving layer 20, and a protective layer 22 of the type described above has been laminated onto the printed label 21 so as to cover the label 21.

Japanese Patent Application No. 2004-271399 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of printing onto a golf ball box or golf ball packaging medium, the method being comprised of printing a label that includes lettering or a design onto a surface of the box or packaging medium with an inkjet printer.

2. The printing method of claim 1, wherein the box or packaging medium has a three-dimensional shape.

3. The printing method of claim 1, wherein the inkjet printer is an on-demand printer.

4. The printing method of claim 1, wherein the inkjet printer uses a water-based pigment ink.

5. The printing method of claim 1, wherein the box or packaging medium has an image-receiving layer which absorbs an ink solvent and on a surface of which the label is printed.

6. The printing method of claim 5, wherein the image-receiving layer is composed of at least one water-absorbing film.

7. A printed golf ball box which comprises:
a golf ball box having a surface, and
a label that includes lettering or a design printed on the surface of the box with an inkjet printer.

8. The printed golf ball box of claim 7 which additionally comprises a protective layer formed on a surface of the label so as to cover the label.

9. A printed golf ball packaging medium which comprises:
a golf ball packaging medium having a surface, and
a label that includes lettering or a design printed on the surface of the packaging medium with an inkjet printer.

10. The printed golf ball packaging medium of claim 9 which additionally comprises a protective layer formed on a surface of the label so as to cover the label.
